(19) United States
(12) Patent Application Publication
(10) Pub. No.: US 2021/0192675 A1
(43) Pub. Date: Jun. 24, 2021

(54) GRAPHICS PROCESSOR UNIT, PLATFORM COMPRISING SUCH A GRAPHICS PROCESSOR UNIT AND A MULTI-CORE CENTRAL PROCESSOR, AND METHOD FOR MANAGING RESOURCES OF SUCH A GRAPHICS PROCESSOR UNIT

(71) Applicant: THALES, Courbevoie (FR)

(72) Inventor: Alexandre FINE, Merignac (FR)

(21) Appl. No.: 17/120,911

(22) Filed: Dec. 14, 2020

(30) Foreign Application Priority Data
Dec. 19, 2019 (FR) 19 14873

(51) Int. Cl. G06T 1/20; G06F 15/80

(52) U.S. Cl. CPC G06T 1/20; G06F 15/80

(57) ABSTRACT

This graphics processor unit is intended to be connected to a multi-core central processor unit having N distinct cores, N being an integer greater than or equal to 2, and comprises a memory storage unit.

The memory storage unit comprises a reserved space for storing N sets of descriptor(s), each set of descriptor(s) being associated with a respective core of the multi-core central processor unit, each descriptor identifying a batch of resource(s) of the graphics processor unit for the display of data by a software application intended to be executed via said respective core.

The graphics processor unit further comprises a sequencer configured to successively process the descriptors stored in the reserved storage space.

### CROSS-REFERENCE TO RELATED APPLICATIONS

This application is a U.S. non-provisional application claiming the benefit of French Application No. 19 14873, filed on Dec. 19, 2019, which is incorporated herein by reference in its entirety.

### FIELD

The present invention relates to a graphics processor unit intended to be connected to a multi-core central processor unit having N distinct cores, N being an integer greater than or equal to 2.

The invention also relates to a platform comprising such a graphics processor unit and a multi-core central processor unit having N distinct cores, connected to the graphics processor unit.

The invention also relates to a resource management method for managing the resources of a graphics processor unit, the method being implemented by such a graphics processor unit.

The invention relates to the field of data display systems, preferably intended to be installed on board an aircraft, in particular in an aircraft cockpit.

The invention relates in particular to the field of graphics processor units included in these display systems, these graphics processor units also being generally known as GPU (abbreviation for Graphic Processing Unit). Such graphics processing units are typically produced in the form of one or more dedicated integrated circuits, such as one or more ASICs (abbreviation for Application Specific Integrated Circuit).

Each graphics processor unit is generally connected to a central processor unit, in particular a multi-core processor unit, to form a platform, the central processor unit also generally being known as a CPU (abbreviation for Central Processing Unit).

### BACKGROUND

A platform of the aforementioned type is thus already known which has an architecture referred to as symmetric multi-processing, also known as SMP (abbreviation for Symmetrical Multi-Processing) architecture. Such a platform generally hosts a single operating system for all the cores of the multi-core processor unit, and the operating system then manages the access of each of the cores to the various other elements of the platform, in particular to the graphics processor unit.

However, a platform with such a symmetric multi-processing architecture is not always suitable.

### SUMMARY

The object of the invention is therefore to provide a graphics processor unit, and an associated resource management method for managing the resources, that enables the operation of the platform comprising the graphics processor unit based on a so-called asymmetric multi-processing architecture, also known as AMP (abbreviation for Asymmetrical Multi-Processing) architecture.

To this end, the invention relates to a graphics processor unit intended to be connected to a multi-core central processor unit having N distinct cores, N being an integer greater than or equal to 2, the graphics processor unit comprising a memory storage unit;

the memory storage unit comprising a reserved space for storing N sets of descriptor(s), each set of descriptor(s) being associated with a respective core of the multi-core central processor unit, each descriptor identifying a batch of resource(s) of the graphics processor unit for the display of data by a software application intended to be executed via said respective core; and the graphics processor unit further comprising a sequencer configured to successively process the descriptors stored in the reserved storage space.

Thus, the graphics processor unit according to the invention makes it possible, through the storage space reserved for N sets of descriptor(s) and the sequencer capable of successively processing the descriptors stored in said storage space, to execute the sharing of resources of the graphics processor unit directly at the graphics processor unit level, rather than at the operating system level as is done with a platform and a graphics processor unit of the state of the art.

According to other advantageous aspects of the invention, the graphics processor unit comprises one or more of the following characteristic features, taken into consideration individually or according to all technically possible combinations:
the reserved storage space comprises N distinct storage zones, each zone being capable of storing a respective set of descriptor(s), the N storage zones being separated to one another;
the sequencer is configured to process zone by zone the descriptors stored in the reserved storage space;
each storage zone comprises one or more distinct storage sectors, each sector being capable of storing a respective subset of descriptor(s) for a respective software application adapted to be executed by the core associated with said storage zone, the one or more storage sectors being separated to one another;
the sequencer is configured to process sector by sector the descriptors stored in a respective storage zone;
a maximum time interval is associated with each storage sector, and the sequencer is configured to, when the maximum time interval is reached, interrupt the processing of the one or more descriptor(s) for a current sector and to proceed to the processing of the one or more descriptor(s) for a subsequent sector;

the sequencer being, preferably and in the event of interruption of the respective processing of descriptor(s), configured to save, in a storage location, a state of execution of each descriptor whose processing is interrupted, for subsequent resumption of the interrupted processing;
a priority level is associated with each sector, and when a respective storage zone comprises multiple distinct storage sectors, the sequencer is further configured to process said storage sectors in a monotonic order of priority levels thereof; and
each descriptor comprises one or more information items selected from the group consisting of: an identifier of a graphics context; an identifier of a graphic surface; maximum execution time; and an identifier of a command and execution stack.

The object of the invention also relates to a platform comprising a graphics processor unit and a multi-core central processor unit having N distinct cores, N being an integer greater than or equal to 2, the graphics processor unit being connected to the central processor unit and as defined above.

The object of the invention also relates to a resource management method for managing the resources of a graphics processor unit, the method being implemented by the graphics processor unit, the graphics processor unit comprising a memory storage unit and being intended to be connected to a multi-core central processor unit having N distinct cores, N being an integer greater than or equal to 2;

the method comprising the following steps:
allocating, in the memory storage unit, a reserved space for storing N sets of descriptor(s), each set of descriptor(s) being associated with a respective core of the multi-core central processor unit, each descriptor identifying a batch of resource(s) of the graphics processor unit for the display of data by a software application intended to be executed via said respective core; and
successively processing the descriptors stored in the reserved storage space.

### BRIEF DESCRIPTION OF THE DRAWINGS

These features and advantages of the invention will become apparent upon reading the description which follows, given solely by way of non-limiting example, and made with reference to the appended drawings, in which:

FIG. 1 is a schematic representation of an avionics system according to the invention, intended to be installed on board an aircraft and comprising an avionics platform, the platform comprising a central processor unit and a graphics processor unit connected to the central processor unit;

FIG. 2 is a flowchart of a method, according to the invention, for managing the resources of the graphics processor unit of FIG. 1, the method being implemented by said graphics processor unit;

FIG. 3 is a timeline schematic representing the preparation by the central processor unit, then by the graphics processor unit, and finally the display of an image on a display screen, according to a first mode of operation;

FIG. 4 is a view analogous to that in FIG. 3, according to a second mode of operation; and

FIG. 5 is a view analogous to that in FIG. 3 according to a third mode of operation.

### DETAILED DESCRIPTION

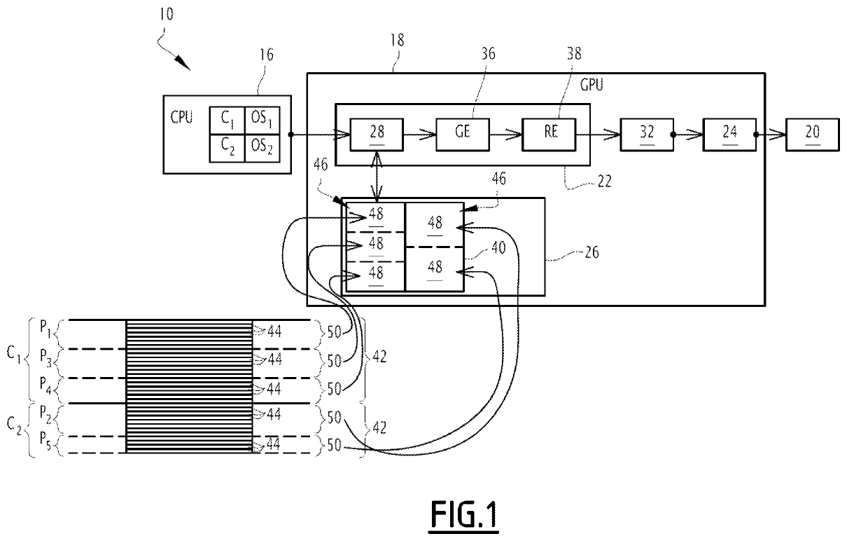

In FIG. 1, an avionics system 10, intended to be installed on board an aircraft, not shown, comprises an avionics platform 12.

The avionics platform 12 comprises a central processor unit 16, also known as CPU (abbreviation for Central Processing Unit), and a graphics processor unit 18, also known as GPU (abbreviation for Graphic Processing Unit), the graphics processor unit 18 being connected to the central processor unit 16. The central processor unit 16 is a multi-core central processor unit having N distinct cores C₁, . . . C_{N}, N being an integer greater than or equal to 2.

In addition, the platform 12 comprises a display screen 20, connected for example to the graphics processor unit 18.

As a complementary option, the architecture of the platform 12 is a so-called asymmetric multi-processing architecture, also known as AMP (abbreviation for Asymmetrical Multi-Processing) architecture. According to this complementary option with AMP architecture, the platform 12 is also capable of hosting distinct operating systems OS₁, . . . OS_{N}, each operating system OS₁, . . . OS_{N} being associated with a respective core C₁, . . . CN.

The central processor unit 16 is known per se. In the example of FIG. 1, the central processor unit 16 represented is, for the sake of simplification of the drawing, a processor unit with 2 cores C₁, C₂. As a variant, not shown, the number N of distinct cores C₁, . . . C_{N} is equal to 2×P, where P is an integer multiple greater than or equal to 2.

The graphics processor unit 18 comprises a generation module 22 for generating at least one set of pixel(s) to be displayed and a display module 24 for displaying each set of pixel(s) on the display screen 20, the display module 24 being connected to the generation module 22.

The graphics processor unit 18 further comprises a memory storage unit 26 for storing data and a sequencer 28. The sequencer 28 is for example integrated into the generation module 22. As a variant, the sequencer 28 is connected to the input of the generation module 22.

The generation module 22 is configured to generate at least one set of pixel(s) to be displayed.

As a complementary option, the generation module 22 is configured to generate at least one intermediate layer of images, not shown, each intermediate layer comprising a respective set of pixel(s).

According to this complementary option, the graphics processor unit 18 further comprises a composition module 32 for composing an image from the intermediate layer(s) generated by the generation module 22, the display module 24 then being able to display the image composed by the composition module 32.

The generation module 22 comprises, for example, a geometric engine 36 capable of generating at least one group of geometric primitive(s) and a rendering engine 38 capable of converting each group of geometric primitive(s) into a respective set of pixel(s). The geometric engine 36 is also known as GE (abbreviation for Geometric Engine), and the rendering engine 38 is also known as RE (abbreviation for Raster Engine, or also Rendering Engine).

The generation module 22, and as a complementary option the composition module 32, form a graphic creation chain for creating a respective image, able to be displayed on the screen 20 by the display module 24. The graphic creation chain is also known as a graphics pipeline.

The display module 24 is configured to generally display each set of pixel(s) on the screen 20, in particular to display each image on the screen 20.

As a complementary option, the display module 24 is also configured to mix a respective image with a video, for example stored in the memory storage 26, and then to display the mix 40 of the image and video on the display screen 20.

The memory storage unit 26 is connected to each of the modules of the graphics processor unit 18, in particular to the generation module 22 and to the display module 24, and as complementary option, as well to the composition module 32.

According to the invention, the memory storage unit 26 comprises a reserved space 40 for storing N sets 42 of descriptor(s) 44, each set 42 of descriptor(s) 44 being associated with a respective core C_{N} of the multi-core central processor unit 16, each descriptor 44 identifying a batch of resource(s) of the graphics processor unit 18 for displaying data by a software application intended to be executed via said respective core C₁, . . . C_{N}.

Each operating system OS₁, . . . OS_{N} is, for example, configured to create the set 42 of descriptor(s) 44 for the core C₁, . . . C_{N} with which it is associated.

The sequencer 28 is configured to successively process the descriptors 44 stored in the reserved storage space 40.

The composition module 32 is configured to compose each image from the corresponding intermediate layer or layers, in particular by positioning said intermediate layer or layers, for example relative to one another, and by superimposing them if necessary.

The geometric engine 36, or GE, is configured to generate at least one group of geometric primitive(s), that is to say to generate a vector image portion.

The rendering engine 38 is then configured to convert each group of geometric primitive(s) into a respective set of pixel(s), i.e. to convert the vector image portion corresponding to the group of geometric primitive(s) into a matrix image portion corresponding to said set of pixel(s). This conversion performed by the rendering engine 38 is also known as rasterization, or also matrixization.

As a complementary option, the reserved storage space 40 comprises N distinct storage zones 46, each zone 46 being able to store a respective set 42 of descriptor(s) 44, the N storage zones 46 being separated to one another.

According to this complementary option, the sequencer 28 is further configured to process, zone 46 by zone 46, the descriptors 44 stored in the reserved storage space 40.

Each descriptor 44 comprises one or more information items chosen from the group consisting of: an identifier of a graphic context; an identifier of a graphic surface; maximum execution time; and an identifier of a command and execution stack.

The term ‘graphical context’, also known as graphical execution context, refers to a collection of states parameterizing the operation of the graphic creation chain, such as, for example, definitions of laws of geometric transformation, values of outline/drawing colours, or erasure values, or also texture identifications to be applied. The person skilled in the art will thus understand that the graphical execution context corresponds, for example, to the “Rendering Context”, defined in the EGL standard, in particular in the document entitled “OpenGL® ES Native Platform Graphics Interface”, version 1.1. 2 Nov. 2004 and subsequent versions.

The term ‘graphic surface’ refers to a space for storing pixels, whether or not intended for display, wherein the graphic creation chain performs a drawing operation. The skilled person will then understand that the graphic surface corresponds, for example, to the “Drawing Surface”, also defined in the aforementioned EGL standard.

As a complementary option, each storage zone 46 comprises one or more distinct storage sectors 48, each sector 48 being capable of storing a respective subset 50 of descriptor(s) 44 for a respective software application adapted to be executed by the core. C₁, . . . , C_{N} associated with said storage zone 46, the one or more storage sectors 48 being separated to one another.

According to this complementary option, the sequencer 28 is preferably further configured to process, sector 48 by sector 48, the descriptors 44 stored in a respective storage zone 46.

In the example of FIG. 1, the reserved storage space 40 comprises two separate storage zones 46, namely a respective storage zone 46 for each of the two cores C₁, C₂. The storage zone 46 associated with the first core C₁ comprises three storage sectors 48, each being for example associated with a respective partition P₁, P₃, P₄ capable of being executed by said first core C₁; and the storage zone 46 associated with the second core C₂ comprises two storage sectors 48, each being associated with a respective partition P₂, P₅ capable of being executed by said second core C₂.

The skilled person will then understand that the descriptors 44 are preferably distributed first by core C₁, . . . , C_{N}, and then by partition P₁, . . . , P_{N} each being executed respectively on a corresponding core C₁, . . . , C_{N}.

In order to transpose to the management of cores, the concept of system partition defined in ARP4754 [Aerospace Recommended Practice 4754, SAE], November 1996 and subsequent versions, where the software applications implement a partition management process, as described by the ARINC 653 P1-5 (Avionics Application Software Standard Interface part 1: required services, Issue 5, September 2019), partition of one, or for one, corresponding core C₁, . . . , C_{N}, implies that a part of the resources associated with said corresponding core C₁, . . . , C_{N}, and each partition is generally associated with the execution of one or more respective software applications, preferably with the execution of a single respective software application. In other words, a respective partition P₁, . . . , P₅ is preferably allocated to each respective software application to be executed by the corresponding core C₁, . . . , C_{N}.

As a complementary option, a maximum time interval is associated with each storage sector 48. According to this complementary option, the sequencer 28 is further configured to, when the maximum time interval is reached, interrupt the processing of the one or more descriptor(s) 44 for a current sector 48 and to proceed to the processing of the one or more descriptor(s) 44 for a subsequent sector 48.

Still according to this complementary option, the sequencer 28 is, preferably and in the event of interruption of the respective processing of descriptor(s) 44, configured to save, in a storage location (not shown), a state of execution of each descriptor 44 whose processing is interrupted, for subsequently resuming the interrupted processing. Each storage location is typically included in the memory storage unit 26, while corresponding to a memory space that is distinct from the reserved storage space 40.

Each maximum time interval is for example between 1 m and 20 ms, more preferably between 2 ms and 10 ms.

Yet as a complementary option, a priority level is associated with each storage sector 48. According to this complementary option, when a respective storage zone 46 comprises multiple distinct storage sectors 48, the sequencer 28 is further configured to process said storage sectors 48 in a monotonic order of priority levels thereof. By way of example, if the highest priority level is a level 1, and lower priority levels are levels 2 and so on, the sequencer 28 is then configured to process said storage sectors 48 according to a rising order of priority levels.

In the example of FIG. 1, the partitions P₁ for the first core C₁ and P₂ for the second core C₂ respectively, have the highest priority level, for example level 1, and the storage sectors 48 associated with these partitions P₁, P₂ will then be processed as top priority by the sequencer 28. The partitions P₃, P₄ associated with the first core C₁, and P₅ respectively associated with the second core C₂, have a lower priority level, for example level 2, and the storage sectors 48 associated with said partitions P₃, P₄ and P₅ will then be processed with lower priority by the sequencer 28, that is to say after the processing of the storage sectors 48 associated with partitions P₁ and P₂.

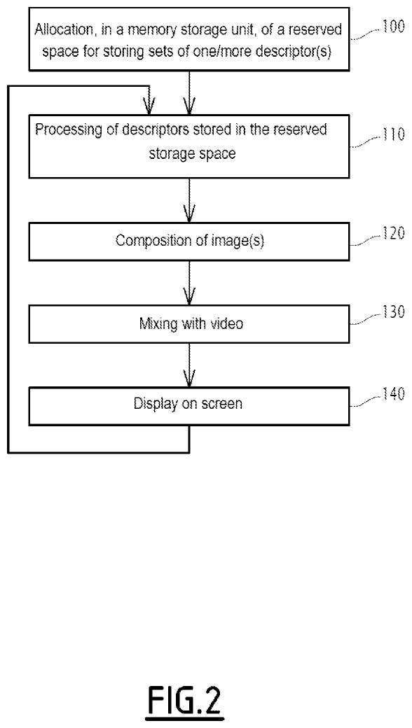

The operation of the avionics system 10 according to the invention, and in particular of the graphics processor unit 18, will now be explained with the aid of FIG. 2 showing a flowchart of a method for displaying pixels on the screen 20, and in particular of a resource management method for managing the resources of the graphics processor unit 18, implemented by the graphics processor unit 18.

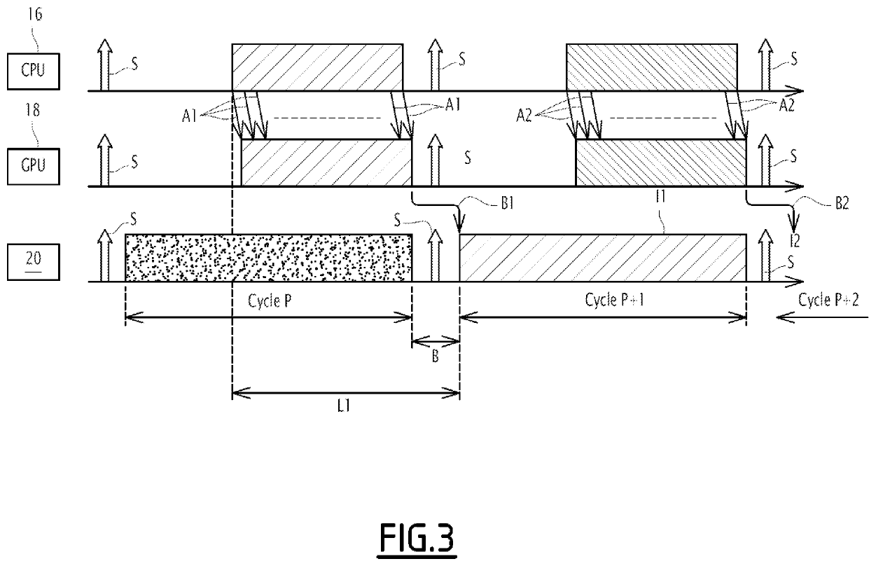

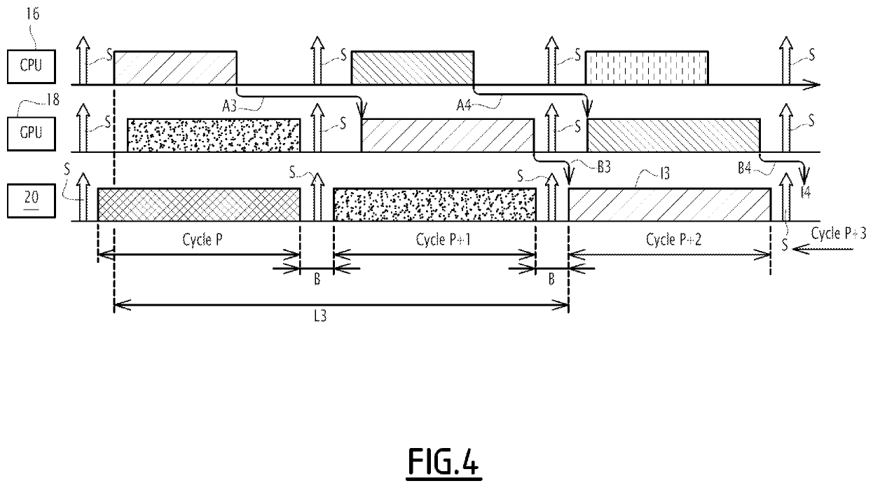

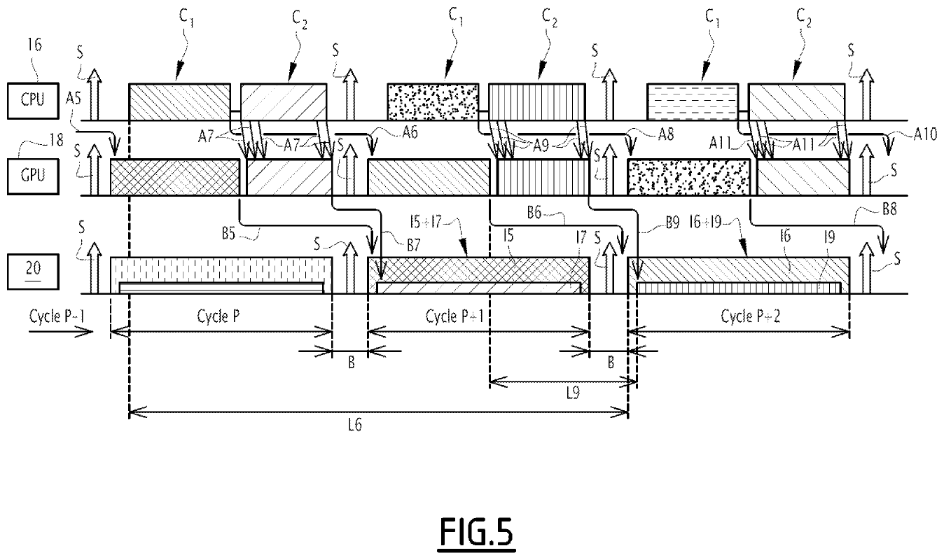

This operation of the avionics system 10 will also be explained with reference to FIGS. 3 to 5 illustrating different modes of operation of the avionics system 10, FIG. 3 corresponding to a first mode of operation, referred to as immediate, FIG. 4 corresponding to a second mode of operation, referred to as timed, and FIG. 5 corresponding to a third mode of operation, referred to as mixed.

In FIG. 2, during an initial step 100, the graphics processor unit 18 allocates in its memory unit 26, the reserved storage space 40 for storing the N sets 42 of descriptor(s) 44. As described previously, each set 42 of descriptor(s) 44 is associated with a respective core C₁, . . . , C_{N} of the multi-core central processor unit 16, and each descriptor 44 identifies a batch of resource(s) of the graphics processor unit 18 for displaying data by a software application intended to be executed via said respective core C₁, . . . , C_{N}.

When as a complementary option the reserved storage space 40 comprises N distinct storage zones 46, each zone 46 being able to store a respective set 42 of descriptor(s) 44, the allocation of each respective storage zone 46 is also performed during this initial allocation step 100. During this allocation of this storage zone 46, the N storage zones 46 are distributed within the reserved storage space 40 so as to be separated from one another. In other words, there is no overlap between two storage zones 46.

When indeed as a complementary option, each respective storage zone 46 comprises multiple distinct storage sectors 48, each sector 48 being capable of storing a respective subset 50 of descriptor(s) 44 for a respective software application, the allocation of said storage sectors 48 is also performed during this allocation step 100. The skilled person will then understand that each sector 48 is allocated within the storage zone 46 corresponding to the core C₁, . . . , C_{N} which is capable of executing the software application associated with said sector 48.

After this initial allocation step 100, the graphics processor unit 18 regularly performs a step 110 of processing of descriptors 44, followed by a step 120 of image composition, followed by an optional step 130 of mixing with a video, finally followed by a step 140 of displaying on the screen 20 of the image, possibly with the video, generated during the preceding steps 110 to 130.

During the processing step 110, the graphics processor unit 18, and in particular its sequencer 28, successively processes the descriptors 44 stored in the reserved storage space 40.

During this processing step 110, and when as a complementary option the reserved storage space 40 comprises N distinct storage zones 46, the sequencer 28 is configured to process, zone 46 by zone 46, the descriptors 44 stored in the reserved storage space 40.

When, yet as a complementary option each storage zone 46 itself comprises multiple distinct storage sectors 48, the sequencer 28 is configured to process, sector 48 by sector 48, the descriptors 44 stored in a respective storage zone 46.

When, as a complementary option, a respective maximum time interval is associated with each storage sector 48, the sequencer 28 interrupts, when a respective maximum time interval is reached, the processing of the one or more descriptor(s) 44 for a current sector 48, and then proceeds to the processing of the one or more descriptor(s) 44 for the subsequent sector 48. According to this complementary option, and in the event of interruption of the respective processing of descriptor(s) 44, the sequencer 28 preferably saves a respective state of execution of each descriptor 44 whose processing is interrupted, doing this in the storage location and for subsequent resumption of said interrupted processing.

When, as yet a complementary option, a respective priority level is adhered to for each sector 48, the sequencer 28 preferably processes said storage sectors 48 in a monotonic order of respective priority levels thereof.

The skilled person will then understand that this processing step 110 makes it possible, via the processing of said descriptors 44, to execute the rendering of graphics commands, previously produced by the central processor unit 16. This execution of rendering of graphics commands comprises, for example, the generation of geometric primitive(s) performed by the geometric engine 36, also denoted GE, followed by a conversion of the generated geometric primitive(s) into one or more respective sets of pixel(s), this conversion being performed by the rendering engine 38, also denoted RE.

Following this processing step 110 resulting in the generation of one or more respective sets of pixel(s), the graphics processor unit 18 performs, via its composition module 32 and during the subsequent step 130, the image composition. This image composition typically consists of composing each image from intermediate layers received from the generation module 22, and more particularly consists in positioning the intermediate layers relative to one another, as well as in superimposing certain layers on top of one another.

The composition step 130 is optionally followed by a mixing step 140 during which the graphics processor unit 18 mixes, via its display module 24, that also plays the role of mixing module, an image composed by the composition module 32 with a video or a video stream, stored in the storage memory storage unit 26, in order to display during the subsequent step 150, the mix of an image and a video.

Obviously, in the absence of the mixing step 140, the display module 24 then displays, during the display step 150, the one or more images composed on the screen 20.

The first, second and third modes of operation of the avionics system according to the invention will now be explained with reference to FIGS. 3 to 5.

In FIG. 3, the first mode of operation, referred to as immediate, corresponds to execution, by the graphics processor unit 18, of rendering of graphics commands produced by the central processor unit 16, as they are progressively produced by the central processor unit 16. In other words, at each execution cycle, the graphics commands produced by the central processor unit 16 are directly transmitted to the graphics processor unit 18, during the same cycle, as represented by the arrows A1 for cycle P, or even by the arrows A2 for cycle P+1, so that rendering of these graphics commands is executed by the graphics processor unit 18 during this same cycle.

The skilled person will note that the transmission, between the central processor unit 16 and the graphics processor unit 18, of the graphics commands is accompanied, according to the invention by the transmission of the descriptors 44 associated with these graphics commands, in order to subsequently distribute the resources of the graphics processor unit 18 during the execution of rendering of said graphics commands by the graphics processor unit 18. In other words, each arrow A1, A2 in FIG. 3, then each of the arrows A3 to A10 in subsequent FIGS. 4 and 5, represents the transmission of both graphics command(s) and associated descriptor(s) 44, this being from the central processor unit 16 to the graphics processor unit 18.

The skilled person will also observe that the time lag between the production of graphics commands at the central processor unit 16 level and the execution of rendering of graphics commands at the graphics processor unit 18 level is only due to the time period of transmission, between the central processor unit 16 and the graphics processor unit 18, of the corresponding graphics command(s) and the associated descriptor(s) 44.

According to this first mode of operation, the graphics commands produced by the central processor unit 16 during the cycle P, the rendering whereof was executed by the graphics processor unit 18 during the same cycle P, then result in the display of an image during the subsequent cycle P+1, as illustrated with the display of the image I1 in FIG. 3. The skilled person will further observe that between two successive cycles P, P+1, switching is necessary in order to pass from the display of one image to the display of the next image, each switch being represented by a vertical and thick lined arrow S, and resulting in a blank period B on the display screen 20.

The skilled person will further understand that it is necessary to perform a switching of frame buffers (accepted terminology) between the graphics processor unit 18 and the display screen 20 at each switching S, this switching of frame buffers making it possible to transmit the information items relating to the display of the image, from the graphics processor unit 18 to the display screen 20, as represented by the arrow B1 for the image I1.

Similarly, the graphics commands produced by the central processor unit 16 during the cycle P+1, the rendering whereof is executed by the graphics processor unit 18 during the same cycle P+1, as illustrated by the arrows A2 for the transmission of the graphics commands and associated descriptors 44, then result in the display of the image 12 during the cycle P+2, the information items relating to this image 12 being transmitted between the graphics processor unit 18 and the display screen 20 during the switching S between cycle P+1 and cycle P+2, as represented by arrow B2.

The skilled person will understand that in each of FIGS. 3 to 5, the production of a group of graphics command(s) by the central processor unit 16, the execution of rendering of this same group of graphics command(s) by the graphic processor unit 18, and finally the display on the screen 20 of the rendering of this same group of graphics command(s), are schematically represented by rectangles having the same fill, in order to illustrate that they are successive actions associated with the same group of graphics command(s).

FIG. 4 illustrates the second mode of operation, referred to as timed, in which the graphics commands produced during the cycle P by the central processor unit 16 are only processed by the graphics processor unit 18 during the subsequent cycle P+1, which then results in the display of the image during the next subsequent cycle P+2 on the display screen 20.

In the example of FIG. 4, the image 13 displayed during the cycle P+2 thus results from graphic commands produced by the central processor unit 16 during the cycle P, then transmitted, with the associated descriptors 44, to the graphics processor unit 18 during the switching S between the cycle P and the cycle P+1, as represented by the arrow A3. The execution of the graphic rendering of the commands produced during cycle P is then effected by the graphics processor unit 18 during the subsequent cycle P+1 and the image 13 is then displayed during the next subsequent cycle P+2, the data relating to the relative image 13 being transmitted between the graphics processor unit 18 and the display screen 20 during the switching S between the cycle P+1 and the cycle P+2, as represented by the arrow B3.

Here again, each switching between two successive cycles results in a blank period B on the display screen 20.

Similarly, the graphics commands produced by the central processor unit 16 during the cycle P+1 are transmitted, with the associated descriptors 44, during the switching S between cycle P+1 and cycle P+2, as represented by arrow A4, in order for the rendering of these graphics commands to be executed during the subsequent cycle P+2 by the graphics processor unit 18, so as to finally result in display of the image 14 during the next subsequent cycle P+3, the information items to be displayed for the image 14 being transmitted between the graphics processor unit 18 and the display screen 20 during the switching S between cycle P+2 and cycle P+3, as represented by arrow B4.

The skilled person will then observe that according to the first mode of operation, referred to as immediate, and visible in FIG. 3, the latency between a time instant of production of the graphic command and the resulting display on the display screen 20 is reduced, and is in particular lower than that according to the second mode of operation, referred to as timed. As an example of comparison between the latency according to the first mode of operation and the latency according to the second mode of operation, The skilled person will observe that the latency, represented by the arrow LA visible in FIG. 3, for the display of the image I1 according to the first mode of operation is much lower than the latency, represented by the arrow L3 visible in FIG. 4, for the display of the image 13 according to the second mode of operation.

Conversely, The skilled person will understand that the first mode of operation, referred to as immediate, requires having a central processor unit 16 which is synchronous with the graphics processor unit 18, and the execution times of the central processor unit 16 then depend on the corresponding execution times of the graphics processor unit 18, which may prove to be penalizing in terms of performance.

On the other hand, according to the second mode of operation, referred to as timed, the central processor unit 16 operates asynchronously relative to the graphics processor unit 18, and the processing times between the central processor unit 16 and the graphics processor unit 18 are then decoupled.

In FIG. 5, the third mode of operation, referred to as mixed, is a mix of the first and second modes of operation described above. More precisely, during each cycle P, P+1, P+2, the avionics system 10 operates partially in timed mode, corresponding to the second mode of operation described above with reference to FIG. 4, and partially in immediate mode, corresponding to the first mode of operation described with reference to FIG. 3.

The central processor unit 16 being a multi-core processor, this distribution of the modes of operation is for example carried out core by core, with one or more cores operating in immediate mode and one or more cores operating in timed mode. In other words, during each cycle P, P+1, P+2, on the one hand, certain graphics commands produced by the central processor unit 16 are transmitted with the corresponding descriptors 44 during the same respective cycle, to the graphics processor unit 18 in order for their rendering to be executed during this same cycle, this immediate transmission being illustrated by the arrows A7 for cycle P, A9 for cycle P+1 and A11 for cycle P+2. On the other hand, other graphics commands produced by the central processor unit 16 during a cycle P, P+1, P+2, typically by another core of the central processor unit 16, are transmitted only during the subsequent cycle P+1, P+2, P+3 to the graphics processor unit 18 in order for their rendering to be executed during this subsequent cycle P+1, P+2, P+3, which thus then results in the display of the image portion corresponding to the next subsequent cycle P+2, P+3, P+4.

In the example of FIG. 5, the combination of portions 15 and 17 of images displayed during cycle P+1 then results:
on the one hand, from graphics commands produced during cycle P−1, for example by the first core C₁, transmitted during the switching S between the cycle P−1 and the cycle P, from the central processor unit 16 to the graphics processor unit 18, as represented by the arrow A5, in order for their rendering to be executed during the cycle P, and for the rendering information items to be then transmitted from the graphics processor unit 18 to the display screen 20 during the switching S between the cycle P and the cycle P+1, as represented by the arrow B5, for the display of the image portion 15 during the cycle P+1; and
on the other hand, from the production of graphics commands by the central processor unit 16, for example by the second core C₂, then from the transmission during this same cycle P and to the graphics processor unit 18, as represented by the arrows A7, of commands produced by the second core C₂, in order for their rendering to be executed by the graphics processor unit 18, still during this cycle P, said rendering then being transmitted during the switching S between the cycle P and the cycle P+1, as represented by the arrow B7, for the display of the image portion 17 during cycle P+1.

Similarly, the portions 16 and 19 of images displayed during cycle P+2 on the display screen 20 result, on the one hand, from the graphic commands produced, for example by the first core C₁ during the cycle P, transmitted along the arrow A6 during the switching S between the cycle P and the cycle P+1 to the graphics processor unit 18, the rendering whereof is then executed during the cycle P+1 by the graphics processor unit 18, said rendering then finally being transmitted, along the arrow B6, during the switching S between cycle P+1 and cycle P+2, for displaying the image portion 16 during cycle P+2; and on the other hand, from graphics commands produced during cycle P+1, for example by the second core C₂, said commands being transmitted along the arrows A9 during this same cycle P+1 to the graphics processor unit 18 in order for their rendering to be executed during this same cycle P+1, and the rendering being then transmitted during the switching S between cycle P+1 and cycle P+2 along the arrow B9, for displaying the image portion 19 during cycle P+2.

The skilled person will then observe that the latency, represented by the arrow L9 for the image portion 19 is much lower than the latency, represented by the arrow L6 for the image portion 16, which in other words, makes it possible to have differentiated latencies for portions of images 16, 19 displayed during a same given cycle, such as cycle P+2 in this example of FIG. 5.

The skilled person will then understand that this third mode of operation illustrated in FIG. 5, referred to as mixed mode, makes it possible to display more rapidly the data that are important for the avionics system 10, while also allowing for slower display for data of less importance, such as background data.

The mixed mode then typically makes it possible to display in immediate mode, that is to say more rapidly, important data, such as position, attitude, roll, altitude, that is to say the minimum parameters for piloting the aircraft, in order to favor flight safety, with lower display latency for these crucial data.

Thus, the reserved storage space 40 and the successive processing of the descriptors 44 by the sequencer 28 allows the graphics processor unit 18 to manage the accessing of its resources, emanating from multiple cores C₁, . . . , C_{N} of the central processor unit 16, which then makes it possible to effect the sharing of resources directly at the graphics processor unit 18 level, rather than at the level of an operating system which would be common to the plurality of cores within the central processor unit 16.

The reserved storage space 40 for the descriptors 44 and the processing of said descriptors 44 by the sequencer 28 then makes possible the operation of the avionics platform 12 based on the asymmetric multi-processing architecture, known as AMP architecture.

1. A graphics processor unit intended to be connected to a multi-core central processor unit having N distinct cores, N being an integer greater than or equal to 2, the graphics processor unit comprising a memory storage unit,
wherein the memory storage unit comprises a reserved space for storing N sets of descriptor(s), each set of descriptor(s) being associated with a respective core of the multi-core central processor unit, each descriptor identifying a batch of resource(s) of the graphics processor unit for the display of data by a software application intended to be executed via said respective core; and
wherein the graphics processor unit further comprises a sequencer configured to successively process the descriptors stored in the reserved storage space.

2. The graphics processor unit according to claim 1, wherein the reserved storage space comprises N distinct storage zones, each zone being capable of storing a respective set of descriptor(s), the N storage zones being separated to one another.

3. The graphics processor unit according to claim 2, wherein the sequencer is configured to process zone by zone the descriptors stored in the reserved storage space.

4. The graphics processor unit according to claim 2, wherein each storage zone comprises one or more distinct storage sectors, each sector being capable of storing a respective subset of descriptor(s) for a respective software application adapted to be executed by the core associated with said storage zone, the one or more storage sectors being separated to one another.

5. The graphics processor unit according to claim 4, wherein the sequencer is configured to process sector by sector the descriptors stored in a respective storage zone.

6. The graphics processor unit according to claim 4, wherein a maximum time interval is associated with each storage sector, and the sequencer is configured to, when the maximum time interval is reached, interrupt the processing of the one or more descriptor(s) for a current sector and to proceed to the processing of the one or more descriptor(s) for a subsequent sector.

7. The graphics processor unit according to claim 6, wherein the sequencer is, in the event of interruption of the respective processing of descriptor(s), configured to save, in a storage location, a state of execution of each descriptor whose processing is interrupted, for subsequent resumption of the interrupted processing.

8. The graphics processor unit according to claim 4, wherein a priority level is associated with each sector, and when a respective storage zone includes multiple distinct storage zones, the sequencer is further configured to process said storage sectors in a monotonic order of priority levels.

9. The graphics processor unit according to claim 1, wherein each descriptor comprises one or more information items selected from the group consisting of: an identifier of a graphics context; an identifier of a graphic surface; maximum execution time; and an identifier of a command and execution stack.

10. A platform comprising a graphics processor unit and a multi-core central processor unit having N distinct cores, N being an integer greater than or equal to 2, the graphics processor unit being connected to the central processor unit,
wherein the graphics processor unit is according to claim 1.

11. A resource management method for managing the resources of a graphics processor unit, the method being implemented by the graphics processor unit, the graphics processor unit comprising a memory storage unit and being intended to be connected to a multi-core central processor unit having N distinct cores, N being an integer greater than or equal to 2;
the method comprising the following steps:
allocating, in the memory storage unit, a reserved space for storing N sets of descriptor(s), each set of descriptor(s) being associated with a respective core of the multi-core central processor unit, each descriptor identifying a batch of resource(s) of the graphics processor unit for the display of data by a software application intended to be executed via said respective core, and
successively processing the descriptors stored in the reserved storage space.
